(19) United States
(12) Patent Application Publication
(10) Pub. No.: US 2011/0002122 A1
(43) Pub. Date: Jan. 6, 2011

(54) DUAL-PURPOSE SPOT LAMP

(76) Inventor: Frank Tsao, Dongguan (CN)

Correspondence Address: NORTH AMERICA INTELLECTUAL PROPERTY CORPORATION, P.O. BOX 506, MERRIFIELD, VA, 22116, US

(21) Appl. No.: 12/555,798

(22) Filed: Sep. 8, 2009

(30) Foreign Application Priority Data
Jul. 2, 2009 (CN) 200920161513.5

(51) Int. Cl. F21S 8/00; F21V 23/04; F21V 11/00

(52) U.S. Cl. 362/277; 362/394; 362/368

(57) ABSTRACT

The invention relates to a dual-purpose spot lamp with a photoelectric switch, which can be used outdoor, including a burner component and back plane component, wherein, the photoelectric switch is fixed on the burner component, the burner component and back plane component are joined with a screw joint structure, the back plane component is fixed on a fixture at the using place, and the sensor window of the photoelectric switch faces obliquely upward. When the lamp is used as a wall lamp, the back plane component is a wall-hanging fixation plate and used as a floor lamp. The back plane component mainly includes a pointed plug and swath board. The lamp provided by the invention has a simple and reasonable structure and is easy to install and especially suitable for outdoor use.

### BACKGROUND OF THE INVENTION

1. Field of the Invention

The invention relates to a lamp, and particularly to a lamp with a photoelectric switch which can be used as both a wall lamp and a floor lamp.

2. Description of the Prior Art

Currently, there are a variety of wall lamps and floor lamps. However, a lamp with a photoelectric switch that can be used as both a wall lamp and a floor lamp is not common. It is thus quite necessary to invent such a lamp with a photoelectric switch which can be used as both a wall lamp and a floor lamp and can be fixed easily.

### SUMMARY OF THE INVENTION

The objective of the invention is to provide an easy-to-install lamp with a photoelectric switch that can be used as both a wall lamp and floor lamp.

The objective of the invention is achieved by: a lamp with a photoelectric switch, including a burner component and back plane component, wherein, the photoelectric switch is fixed on the burner component, the burner component and back plane component are joined with a screw joint structure, and the back plane component is fixed on a fixture around the using place.

The structure of the lamp provided by the invention is simple, especially, the function of a wall lamp or a floor lamp can be chosen by a user according to his/her own requirement, and the installation of the lamp is very easily. The user can easily install and use the lamp provided by the invention according to the specific requirement.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating the structure of a lamp provided by the invention, herein, the purpose of the lamp is a wall lamp.

FIG. 2 is a schematic view illustrating that a photoelectric switch is fixed on the turner component of the lamp provided by the invention.

FIG. 3 is a schematic view illustrating the form and location of an outlet in the turner component of the lamp provided by the invention.

FIG. 4 and FIG. 5 are schematic views illustrating the installation of the lamp provided by the invention when the lamp is used as a wall lamp.

FIG. 6 is a view of another embodiment of the lamp provided by the invention, herein, the purpose of the lamp is a floor lamp.

FIG. 7 and FIG. 8 are schematic views respectively illustrating the structure and local enlargement of the pointed plug of the lamp provided by the invention when the purpose of the lamp is a floor lamp.

FIG. 9 and FIG. 10 are schematic views respectively illustrating the forward and backward structure of the swath board of the lamp provided by the invention when the purpose of the lamp is a floor lamp.

FIG. 11 is a schematic view illustrating the steps of installation of the lamp provided by the invention when the lamp is used as a floor lamp.

### DETAILED DESCRIPTION

A detailed description of the features of structure of the lamp provided by the invention is hereinafter given with reference to the drawings.

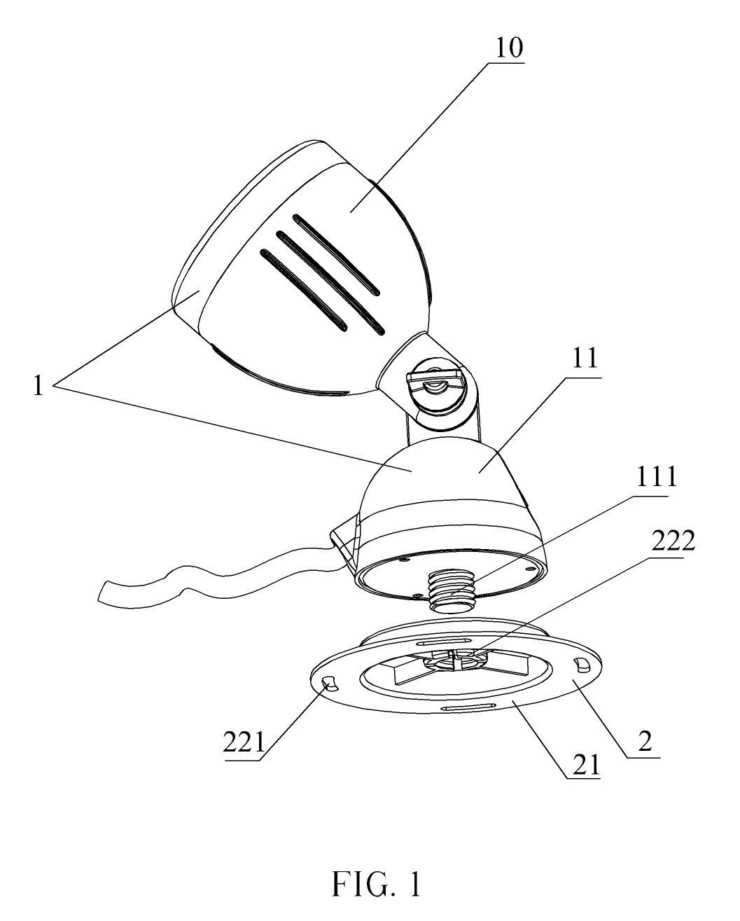

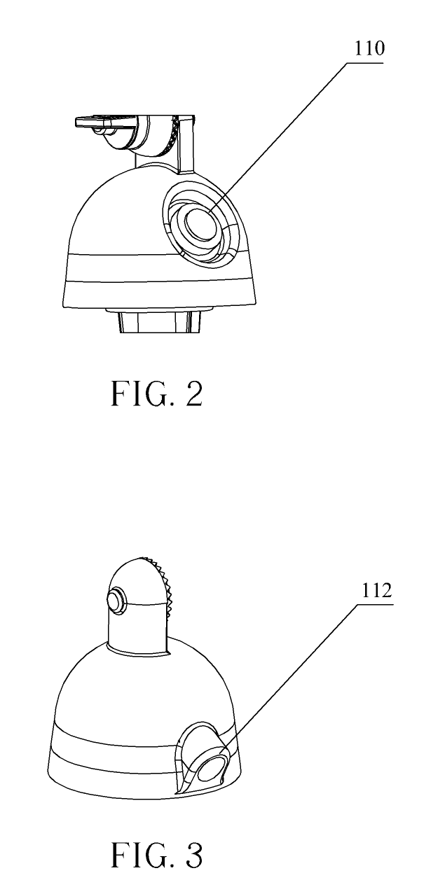

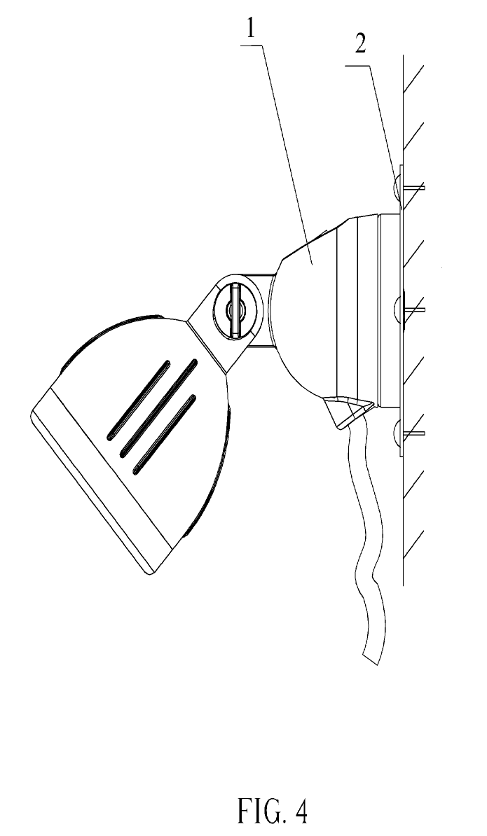

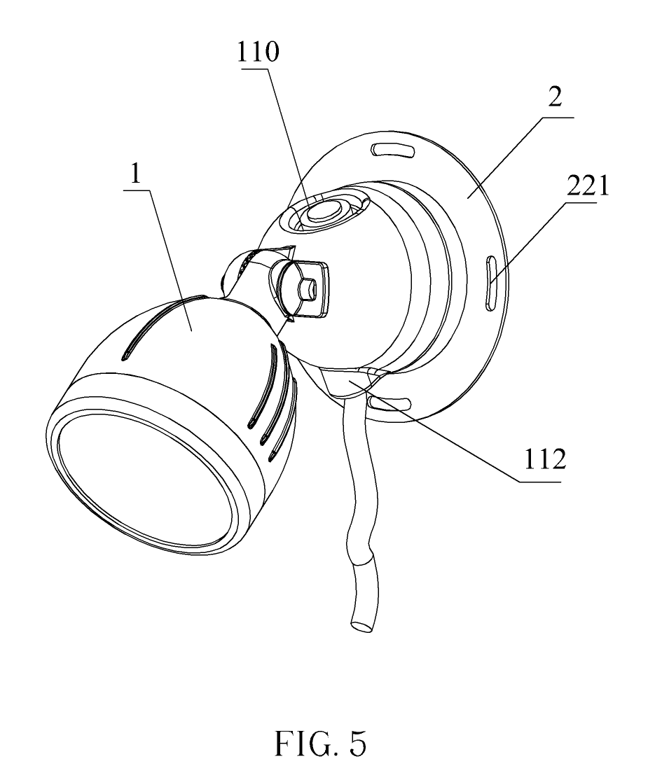

Please refer to FIG. 1 to FIG. 5. FIG. 1 is a schematic view illustrating the structure of a lamp provided by the invention, herein, the purpose of the lamp is a wall lamp. As shown in this Figure, the lamp includes a burner component 1 and back plane component 2. The burner component 1 includes a lamp shade 10 and base 11, wherein, the lamp shade 10 and base 11 can be connected by an adjustable knob, which is a common lamp structure. A photoelectric switch 110 is fixed on the base 11, as shown in FIG. 2 and FIG. 5, and from the figures it can be clearly seen that the sensor window of the photoelectric switch 110 towards to upper sloping, which is specially important since the horizontal direction interference from other debris such as weeds can be avoided, so that the induction degree and sensitivity of the photoelectric switch 110 can be improved and the case of a wrong action or non-action can be avoided.

A bulb and bulb holder are fixed in the lamp shade 10, and the wire is led in through the base 11 and connected with the photoelectric switch 110 and the bulb holder. There is a screw bolt 111 protruding outwards at the bottom of the base 11. It can be seen clearly from FIG. 1, the screw bolt 111 is adopted to connect with the thread nut of the back plane component 2.

As shown in FIGS. 1, 3, 4 and 5, the outlet 112, which is at the lower side of the round edge of the base 11, is of flange short-tube shape. The short-tube of the outlet 112 faces obliquely downward and the wire is installed through the outlet 112. The outlet 112 locates at the side of the base 11, which is opposite side to the sensor window of the photoelectric switch 110. The structure of the outlet 112 is to facilitate the falling of rain. The lamp can be used for outdoor lighting, so such a structure can prevent rainwater flowing into the inner of the lamp.

As shown in FIG. 1 and FIG. 5, when the lamp is used as a wall lamp, the back plane component 2 is a wall-hanging fixation plate 21. The wall-hanging fixation plate 21 is a cap-like structure with an outer edge, and there is a threaded nut hole 222 in the middle of the wall-hanging fixation plate 21. The screw of the threaded nut hole 222 and the screw bolt 111 at the bottom of the base 11 of the burner component 1 are adapted to connect with each other. There are holes 221 in the outer edge, which are used for fixing the lamp on the wall. The holes 221 may be a circle hole or a long arc hole, which are convenient to be fixed with screws.

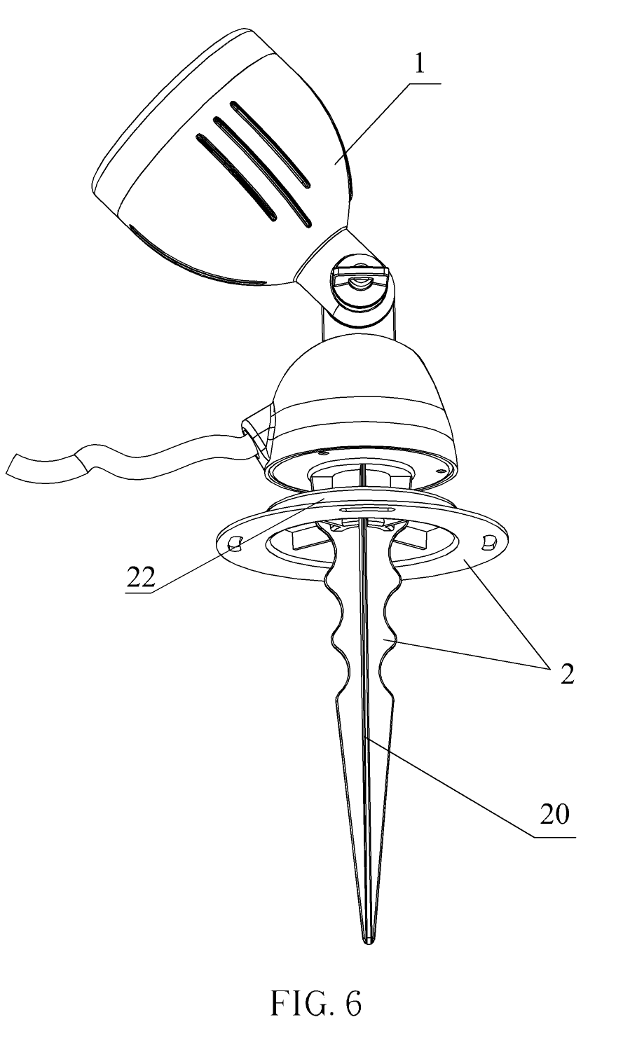

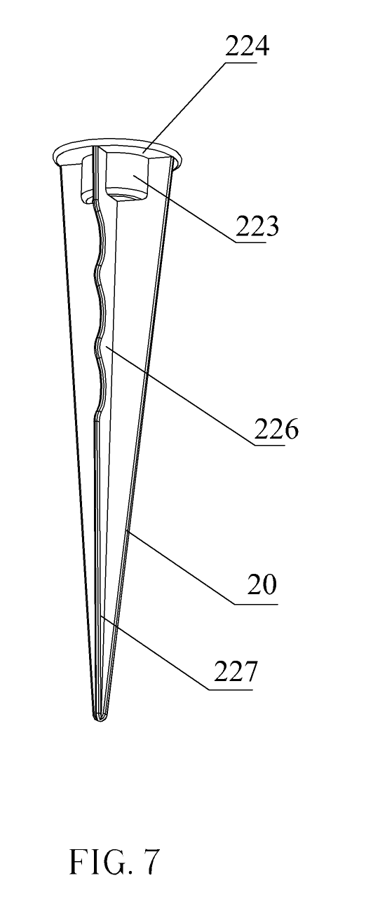

The lamp shown in FIG. 6 to FIG. 11 is the second embodiment of the invention. The lamp also includes a burner component 1 and back plane component 2, and the structure of the burner component 1 is the same with the above embodiment. Wherein, as a floor lamp, the back plane component 2 mainly includes a pointed plug 20 which is used for connecting with the burner component 1 and fixing the entire lamp on the ground. As shown clearly in FIG. 7 and FIG. 8, the pointed plug 20 consists of a number of narrow strip ribs 226, wherein, the ribs are connected together along the narrow strips from the inside, and the outside of the narrow strips are corrugated. The whole shape of the pointed plug 20 has a broad apex and a narrow base. The narrow end at the bottom is a pointed end 227, and there is a processing thread nut 223 in the middle of the upper end. The underside of the processing thread nut 223 is a plane 225 and the upside of the processing thread nut 223 is an annular sheet with a convex porch. The sheet, the processing thread nut and the ribs of the pointed plug are integrated. The thread of the processing thread nut 223 and the screw bolt 111 at the bottom of the base 11 of the burner component 1 are connected to each other.

In the Figure, the number of the ribs 226 of the pointed plug 20 is four. The use of the ribs makes the structure simple and makes the pointed plug have enough strength; so that the whole lamp can be inserted into the ground easily through the pointed end, and also the lamp can be fixed firmly and be prevented from rotating since the ribs are compacted by the soil.

FIG. 8 also shows the hollow status of the processing thread nut 223 of the pointed plug 20. The bottom of the hollow is marked by the numeral 228, which is a requirement for falling of aluminum chips during the processing. Hence the structure is simple, reasonable, and easy to install.

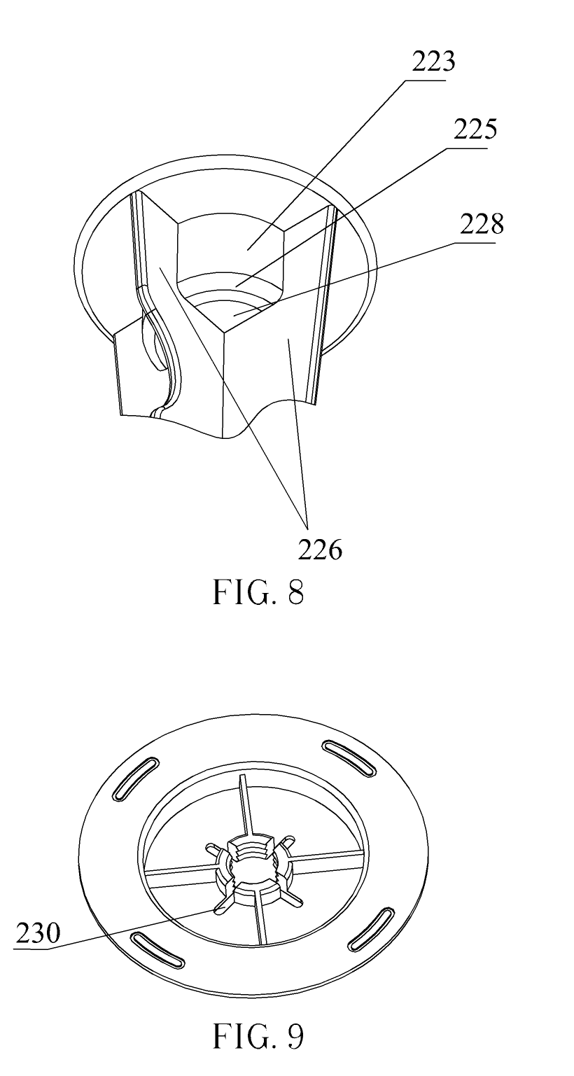

As shown in FIG. 9 and FIG. 10, as a floor lamp, the back plane component 2 further includes a swath board 22, which is a cap-like structure with an outer edge. In the middle of the swath board, there are rib holes 230 spreading outward from the center, and the number of the rib holes 230 are the same with the number of ribs. The orifice size of the rib hole 230 matches the pointed plug 20, so that the pointed end 227 of the pointed plug 20 can be inserted through the orifice, reach the underside plane 225 of the processing thread nut 223 of the pointed plug 20 and touch the plane of the swath board 22 directly. Since the swath board 22 is the cap-like structure with an outer edge, when the swath board 22 and the pointed plug 20 are used together, the whole lamp can be fixed in the ground more firmly, and is harder to incline. The swath board 22 prevents the underside grass growing, so it is not easy to influence the work of the photoelectric switch 110.

The wall-hanging fixation plate 21 and the swath board 22 may have the same structure or different structures. Though their functions are different, their aims are blocking grass and wall hanging respectively. If the two adopts the same structure, it will be more cost-effective for the manufacturer.

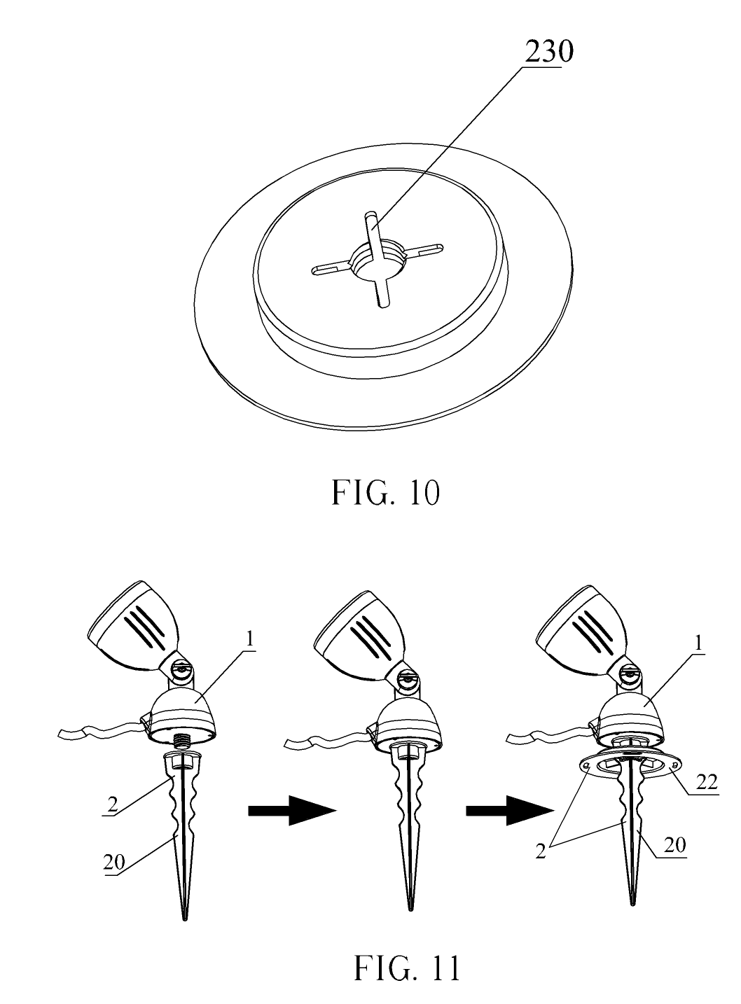

Referring to FIG. 11, FIG. 11 is a schematic view illustrating the steps of installation process of the lamp provided by the invention when the lamp is used as the floor lamp. There are three figures totally from left to right. In the left figure, the burner component 1 and the pointed plug 20 which is the main part of the back plane component 2 are still separated and are about to be installed. In the middle figure, the pointed plug 20 is already connected with the burner component 1 by screwing the nut at the top end of the pointed plug 20 into the screw bolt at the bottom of the burner component 1. In the right figure, the swath board 22 is installed; and the whole lamp is assembled completely and can be inserted into the ground.

The lamp provided by this invention has a simple, reasonable structure and is easy to install. The lamp can be used indoors and outdoor by using the same burner component land is especially suitable for outdoor use due to the water-proof function.

Those skilled in the art will readily observe that numerous modifications and alterations of the device and method may be made while retaining the teachings of the invention.

What is claimed is:

1. A lamp, characterized by, having a photoelectric switch, being suitable for outdoor use, comprises a burner component and back plane component, wherein, the photoelectric switch is fixed on the burner component, the burner component and back plane component are joined with a screw joint structure, and the back plane component is fixed on a fixture at a using place.

2. The lamp of claim 1, wherein the burner component comprises a lamp shade and base, the lamp shade and base can be connected by an adjustable knob, the photoelectric switch is fixed on the base, the sensor window of the photoelectric switch faces towards to upper sloping, a bulb and bulb holder are fixed in the lamp shade, and a wire is led in through the base and connected with the photoelectric switch and the bulb holder.

3. The lamp of claim 2, wherein there is a screw bolt protruding outwards at a bottom of the base and the screw bolt is adopted to connect with a thread nut of the back plane component.

4. The lamp of claim 2, wherein an outlet, which is at a lower side of a round edge of the base, is of flange short-tube shape, a short-tube of the outlet faces obliquely downward and the wire is installed through the outlet; the outlet locates at one side of the base, which is opposite side to a sensor window of the photoelectric switch.

5. The lamp of claim 1, wherein as a wall lamp, the back plane component is a wall-hanging fixation plate; the wall-hanging fixation plate is a cap-like structure with an outer edge, and there is a threaded nut hole in the middle of the wall-hanging fixation plate; a screw of the threaded nut hole and a screw bolt at a bottom of the base of the burner component can be connected with each other; there are holes in the outer edge, which are used for fixing the lamp on the wall.

6. The lamp of claim 1, wherein as a floor lamp, the back plane component mainly comprises a pointed plug, used for connecting with the burner component and fixing the entire lamp on the ground; the pointed plug consists of a number of narrow strip ribs, wherein, the ribs are connected together along the narrow strips from the inside; a whole shape of the pointed plug has a broad apex and a narrow base; a narrow end at the bottom is a pointed end, and there is a processing thread nut in the middle of an upper end; an underside of the processing thread nut is a plane and a top surface of the processing thread nut is an annular sheet with a convex porch; the sheet, the processing thread and the ribs of the pointed plug are integrated; a female thread of the processing thread nut and the screw bolt at the bottom of the base of the burner component are connected to each other.

7. The lamp of claim 6, wherein the number of the ribs of the pointed plug is three to six, the best is three to four.

8. The lamp of claim 6, wherein an outside of the ribs of the pointed plug is corrugated.

9. The lamp of claim 6, wherein as a floor lamp, the back plane component further includes a swath board, which is a cap-like structure with an outer edge; in the middle of the swath board, there are rib holes spreading outward from the center, and the number of the rib holes are the same with the number of ribs; an orifice size of the rib hole matches the pointed plug, so that the pointed end of the pointed plug can be inserted through the orifice, and reach the underside plane of the processing thread nut of the pointed plug and touch the plane of the swath board directly.

10. The lamp of claim 9, wherein the wall-hanging fixation plate and the swath board have the same structure or different structures.
